(19) United States
(12) Patent Application Publication
(10) Pub. No.: US 2005/0121292 A1
(43) Pub. Date: Jun. 9, 2005

(54) Suspension-type conveying arrangement for transporting conveyable-article carriers

(76) Inventor: Walter Braunmuller, Kaufering (DE)

Correspondence Address: Edwards & Angell, LLP, P.O. Box 55874, Boston, MA, 02205, US

(21) Appl. No.: 10/987,552

(22) Filed: Nov. 12, 2004

(30) Foreign Application Priority Data
Nov. 12, 2003 (DE) 103 52 782.6

(51) Int. Cl. B65G 47/46

(52) U.S. Cl. 198/465.4; 198/463.4; 198/479.1

(57) ABSTRACT

The invention proposes a suspension-type conveying arrangement having guide rails (2) for hooks (6) of clothes hangers (4) which are displaceably guided in a suspended manner thereon, and having a diverter (15) with a switchable diverter-tongue element (14) which, in a first switching position (FIG. 1a), connects two successive guide-rail sections (2a, 2b) of a first conveying path and, in a second switching position (FIG. 2a), leaves a gap (20) between the two guide-rail sections (2a, 2b), with the result that conveyable-article-carrier hooks (6) which are guided up to the gap (20) along the first conveying path can pass through the gap (20) to a guide rail (2c) of a second conveying path. The diverter-tongue element (14) can be moved forwards essentially rectilinearly along the first conveying path from one of the guide-rail sections (2a, 2b) in the direction of the other guide-rail section (2b, 2a) in order to pass from the second switching position into the first switching position.

The invention relates to a suspension-type conveying arrangement for transporting conveyable-article carriers, having guide rails for hooks of conveyable-article carriers, in particular clothes hangers, which are displaceably guided in a suspended manner thereon, and having at least one diverter with a guide-rail element which is designed as a switchable diverter-tongue element and, in a first switching position, connects two successive guide-rail sections of a first conveying path, in order to direct conveyable-article carriers from the one guide-rail section to the other guide-rail section, and, in a second switching position, leaves a gap between the two guide-rail sections, with the result that conveyable-article-carrier hooks which are guided up to the gap along the first conveying path can leave the first conveying path through the gap and, if appropriate, pass to a guide rail of a second conveying path.

Suspension-type conveying arrangements like those mentioned above are often used, for example, in the clothing industry for transporting items of clothing, the items of clothing hanging on clothes hangers which serve as conveyable-article carriers, i.e. as transporting means, in the suspension-type conveying arrangement. In this case, the conveyable-article carriers hang, by way of their hooks, on a relevant guide rail of the suspension-type conveying arrangement, it being possible for them to slide along the guide rail. Suspension-type conveying arrangements like those in question here are usually equipped with a traction drive for the conveyable-article carriers, the traction drive having a traction belt, e.g. in the form of a traction chain, which is driven for movement along the conveying path and on which carry-along elements for the conveyable-article carriers are arranged in a row. The carry-along elements may be, for example, pins which project downwards from the traction belt and can engage behind conveyable-article-carrier hooks on the guide rail in order to carry them along the relevant conveying path.

Suspension-type conveying arrangements in the case of which the traction drive has pins as the carry-along elements are also referred to as pin conveyors. It is also possible, however, to have other drive concepts for a suspension-type conveying arrangement such as that which is in question here, e.g. one in which the traction drive is provided with catches as carry-along elements.

The suspension-type conveying arrangements can execute sorting steps or order-picking steps by means of the diverters. In this case, each diverter is switched by means of a diverter-control arrangement in accordance with identification data or destination information provided as machine-readable markings on the conveyable-article carriers fed to the diverter in each case or on the articles located on the conveyable-article carriers. In order to detect these markings, the diverter is assigned a data-acquisition unit. Depending on the type of markings used, this may be, for example, a barcode-reading unit or a transponder unit in the vicinity of the diverter.

A known suspension-type conveying arrangement with diverter is described, for example, in DE 100 26 092 A1. This arrangement is a pin conveyor in which a traction chain is provided with carry-along elements which project downwards in relation to the guide rail and can engage behind hooks of conveyable-article carriers hanging on the guide rail in order to carry them along the conveying path.

The diverter of this known suspension-type conveying arrangement comprises, as the diverter-tongue element, a guide-rail element which can be pivoted about a horizontal pivot axis. In a first switching position of the diverter, the diverter-tongue element connects two successive guide-rail sections of a first conveying path. The horizontal pivot axis of the diverter-tongue element is defined by an articulation arrangement on the downstream guide-rail section. The diverter-tongue element can be pivoted into a second diverter-switching position by being pivoted in the upward direction about this pivot axis, with the result that the connection between the two guide-rail sections is interrupted by a gap. The hooks of the conveyable-article carriers which then move up to the diverter can fall into the gap and pass onto a guide rail of a second conveying path. In the case of the suspension-type conveying arrangement according to DE 100 26 092 A1, this is a slide bar which leads obliquely downwards and on which the conveyable-article carriers can slide along the second conveying path under the action of their gravitational force.

In order to ensure that, in the case of a suspension-type conveying arrangement such as that explained in DE 100 26 092 A1, it is possible for the diverter, upon transfer from the first switching position into the second switching position, to produce, with a relatively small switching displacement, i.e. a small pivoting angle, a discharging gap which is large enough for the reliable discharge of conveyable-article carrier hooks, it is necessary for the diverter-tongue element to be of relatively long design. The diverter thus requires a comparatively large amount of space and normally needs a relatively powerful switching drive.

The object of the invention is to provide a suspension-type conveying arrangement such as that mentioned in the introduction in the case of which the diverter only requires a small amount of space and can be switched over quickly and reliably between the diverter-switching positions with a comparatively small amount of force being applied.

In order to achieve this object, it is proposed according to the invention that the diverter-tongue element can be moved forwards essentially rectilinearly along the first conveying path from one of the guide-rail sections in the direction of the other guide-rail section in order to pass from the second switching position into the first switching position.

The diverter-tongue element, according to one embodiment of the invention, may be a diverter-tongue element which can be telescopically pushed out and drawn in on the one guide section. It is possible for such a diverter-tongue element, according to the present invention, to be provided, and retained in a movable manner, on the upstream guide-rail section or on the downstream guide-rail section of the diverter.

In accordance with a special construction of the diverter, such a diverter-tongue element is arranged such that it can be displaced back and forth both on the downstream guide-rail section and on the upstream guide-rail section, the two diverter-tongue elements being moved close together in the first switching position of the diverter and being drawn apart from one another, to form the discharging gap for the conveyable-article-carrier hooks, in the second switching position of the diverter.

The diverter-tongue element may be designed to be very small and does not require any great switchover forces for quick and reliable switchover between the two diverter switching positions. In particular, it is easily possible according to the present invention to realise a large discharging gap, if required, using a small diverter-tongue element, for example in order for it to be possible to discharge a group of conveyable-article carriers or conveyable-article carriers with large hook cross sections.

According to a preferred embodiment, in the case of which the diverter-tongue element is arranged in a movable manner on the upstream guide-rail section of the diverter, the switching operation of the diverter can also take place even if a hook is already located on the diverter-tongue element. The diverter can thus be switched with extremely short reaction times, measured from the point in time at which a conveyable-article carrier which is guided up is identified, in order for the relevant conveyable-article carrier to be directed further on the first or on the second conveying path in accordance with the destination assigned to it.

The diverter realised according to the invention can also be operated in upwardly sloping path sections and downwardly sloping path sections of the conveying path.

According to a preferred embodiment of the invention, an interspace which is formed in the first diverter-switching position between the diverter-tongue element and the one guide-rail section is bridged by a guide-rail bridge element. According to a variant of the abovementioned embodiment, this guide-rail bridge element may be arranged on the diverter-tongue element, to be precise such that it can overlap laterally with the one guide-rail section when the diverter-tongue element is transferred into the second switching position. In this overlapping region, conveyable-article-carrier hooks engage over the guide-rail bridge element and the one guide-rail section together.

According to another variant of the abovementioned embodiment of the invention, the guide-rail bridge element is arranged on the one guide-rail section, to be precise such that it can overlap laterally with the diverter-tongue element when the diverter-tongue element is transferred into the second switching position. In the overlapping region, conveyable-article-carrier hooks can then engage over the guide-rail bridge element and the diverter-tongue element together.

In the case of both variants, the guide-rail bridge element is preferably a plate part of which the top periphery is located at least more or less in a common plane with the top periphery of the diverter-tongue element and the top periphery of the one guide-rail section in the region of the diverter.

Such a plate part is preferably provided on both sides of the diverter-tongue element or of the guide-rail section.

According to a preferred embodiment, the suspension-type conveying arrangement of the invention has a switching-drive device which is intended for the diverter-tongue element and can be controlled by means of a diverter-control arrangement. The switching-drive device may comprise a pneumatic or a hydraulic cylinder as switching-drive element. An alternative embodiment of the switching-drive device has an electric motor or an electromagnet as switching-drive element.

The switching-drive element is preferably arranged on the one guide-rail section, in particular is integrated therein, the diverter-tongue element being fastened on a diverter-tongue carrier of the switching-drive element, it being possible for this diverter-tongue carrier to be moved forwards and back along the one guide-rail section.

The diverter-tongue element can preferably be moved for sliding action in a state in which it rests on a supporting surface. This supporting surface, according to a development of the invention, is provided on the branching guide rail of the second conveying path.

The diverter-tongue element, at its front end, is preferably equipped with a sloping flank which, in the second switching position, forms a ramp for guiding conveyable-article-carrier hooks away downwards to the second conveying path.

A traction arrangement should be provided at least in association with the first conveying path, this traction arrangement having carry-along elements by means of which the conveyable-article carriers which engage over the guide rail by way of their hooks are carried along. As is known per se, the carry-along elements may be catches, pins, brush elements or carry-along pockets arranged on a traction belt or a traction chain.

In order that the suspension-type conveying arrangement can be used for carrying out more extensive sorting tasks, it is proposed that it comprises a sorting-conveyor region with a plurality of diverters of the type explained above.

Use is preferably made of a diverter-control arrangement which comprises a data-acquisition unit, in particular optical reading unit or transponder unit, in order to detect destination markings or identification markings on the conveyable-article carriers fed to the diverter in each case or on conveyable articles located on the conveyable-article carriers.

A preferred exemplary embodiment of the invention is explained in more detail hereinbelow with reference to the figures, in which:

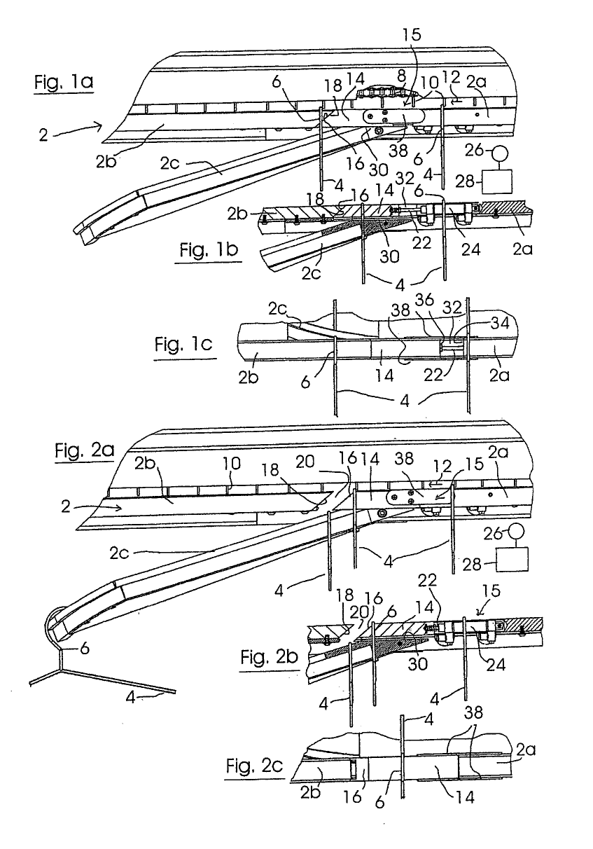

FIG. 1a shows a side view, in detail form, of a diverter region of a suspension-type conveying arrangement according to the invention with a diverter-tongue element located in the first switching position,

FIG. 1b shows a side view, in longitudinal section, of the diverter region of the suspension-type conveying arrangement from FIG. 1a,

FIG. 1c shows a plan view, in detail form, of the diverter region of the suspension-type conveying arrangement from FIG. 1a,

FIG. 2a shows the diverter region of the suspension-type conveying arrangement in a side view, in detail form, similar to FIG. 1a, the diverter-tongue element nevertheless being located in the second switching position,

FIG. 2b shows a side view, in longitudinal section, of the diverter region of the suspension-type conveying arrangement from FIG. 2a, and

FIG. 2c shows a plan view, in detail form, of the diverter region of the suspension-type conveying arrangement from FIG. 2a.

The figures illustrate a diverter region of an exemplary embodiment of a suspension-type conveying arrangement according to the invention.

The suspension-type conveying arrangement comprises a guide-rail set-up 2 with guide-rail sections 2a and 2b which are assigned to a first conveying path. In the case of the example, the suspension-type conveying arrangement serves for transporting items of clothing (not shown) on clothes hangers 4 which, by way of their hooks 6, hang on a relevant guide rail 2 and can be displaced with guidance along the guide rail 2.

A traction arrangement which has a traction chain 8 and carry-along elements 10 projecting downwards from the traction chain 8 is provided for displacing the conveyable-article carriers 4 along the first conveying path. The traction chain 8 is an endless chain which is driven in circulation and moves from right to left, in accordance with the arrow 12, in the diverter region shown. It is possible for the carry-along pins 10 which are guided along to engage, in the manner which is shown in FIG. 1a, behind conveyable-article-carrier hooks 6 on the guide-rail set-up 2 and carry these along for movement along the first conveying path.

FIGS. 1a-1c show a diverter-tongue element 14 in a first switching position, in which conveyable-article carriers 4 which are guided up on the guide-rail section 2a are directed further along the first conveying path, to the guide-rail section 2b, by the diverter-tongue element. The diverter-tongue element 14 is a guide-rail element which can be pushed forwards rectilinearly in the direction of the first conveying path from the guide-rail section 2a and can be drawn back. In the first switching position according to FIG. 1a, the diverter-tongue element 14 is pushed forwards, with the result that it butts, by way of its front sloping flank 16, against a complementary sloping flank 18 of the guide-rail section 2b.

FIGS. 2a-2c show the diverter-tongue element 14 in a second switching position, namely in the position in which it is drawn back to the guide-rail section 2a, a discharging gap 20 for the conveyable-article carriers 4 being produced between the separated sloping flanks 16, 18 of the diverter-tongue element 14 and of the guide-rail section 2b. The conveyable-article-carrier hooks 6 reaching the discharging gap 20 can slide on the sloping flank 16 of the diverter-tongue element 14, this flank being inclined forwards and downwards as seen in the conveying direction, onto a guide rail 2c which is assigned to a second conveying path, that is to say to a conveying path which branches off from the first conveying path. The second conveying path is a downwardly sloping sliding path, it being possible for the conveyable-article carriers 4 to slide to a lower-level destination on the guide rail 2c on account of their gravitational force.

It can be seen in FIGS. 1b and 2b that the diverter-tongue element 14 is fastened on a piston rod 22 of a double-acting pneumatic cylinder 24 and, by virtue of the piston rod 22 being extended out of the pneumatic cylinder 24, can be moved into the first switching position according to FIG. 1b and, by virtue of the piston rod 22 being drawn into the pneumatic cylinder 24, can be moved into the second switching position according to FIG. 2b.

The pneumatic cylinder 24 is part of a diverter-control arrangement, which further comprises a data-acquisition unit 26 and a control computer 28. The data-acquisition unit 26 is arranged upstream in the vicinity of the diverter 15, in order for conveyable-article carriers 4 which approach the diverter 15 to be identified with reference to markings (not shown) located thereon. These markings may be, for example, barcode markings, in which case the data-acquisition unit 26 is a barcode reader by means of which the data detected by it is passed on to the control computer 28. The control computer 28 controls the pneumatic cylinder 24 via a relevant pneumatic arrangement in accordance with the marking data obtained from the reading unit 26, in order for the diverter 15 to be switched into the first switching state or into the second switching state and thus for the conveyable-article carriers 4, in dependence on their marking, either to be directed further along the first conveying path to the second guide-rail section 2b (FIG. 1a) or to be discharged onto the guide rail 2c of the second conveying path (FIG. 2a).

The diverter-tongue element 14 rests on a supporting surface 30 at the top end of the branching guide-rail section 2c, with the result that the piston rod 22 essentially only has to transmit and absorb axial forces.

In order to bridge the interspace 32 between the front end 34 of the guide-rail section 2a and the rear end 36 of the diverter-tongue element 14 in the first switching position of the diverter-tongue element 14 (see FIG. 1c), bridging plates 38 are provided laterally on the diverter-tongue element 14, these plates projecting rearwards beyond the rear end of the diverter-tongue element 14 and overlapping laterally with the guide-rail section 2a. The top peripheries of the bridging plates 38 are located in a common plane with the top peripheries of the guide-rail sections 2a and 2b, i.e. along a common line as seen in the side view according to FIGS. 1a and 1b, with the result that the first conveying path is not interrupted when the diverter tongue 14 is in the first switching position according to FIGS. 1a-1c.

In the case of the preferred exemplary embodiment of the invention which has been explained above, the diverter-tongue element element 14 can be switched from the upstream rail section 2a by means of the pneumatic cylinder 24, which is accommodated in a recess therein. In an alternative embodiment of the invention, a relevant diverter-tongue element can be moved forwards and back from the downstream guide-rail section.

Furthermore, modifications in which it is possible to reverse the conveying direction in particular on the first conveying path are also conceivable within the framework of the invention.

1. Suspension-type conveying arrangement for transporting conveyable-article carriers, having guide rails for hooks of conveyable-article carriers, in particular clothes hangers, which are displaceably guided in a suspended manner thereon, and having at least one diverter with a guide-rail element which is designed as a switchable diverter-tongue element and, in a first switching position, connects two successive guide-rail sections of a first conveying path, in order to direct conveyable-article carriers from the one guide-rail section to the other guide-rail section and, in a second switching position, leaves a gap between the two guide-rail sections, with the result that conveyable-article-carrier hooks which are guided up to the gap along the first conveying path can leave the first conveying path through the gap and, if appropriate, pass to a second conveying path, wherein the diverter-tongue element can be moved forwards essentially rectilinearly along the first conveying path from one of the guide-rail sections in the direction of the other guide-rail section in order to pass from the second switching position into the first switching position.

2. Suspension-type conveying arrangement according to claim 1, wherein the diverter-tongue element can be moved back essentially rectilinearly from the first switching position into the second switching position.

3. Suspension-type conveying arrangement according to claim 1, wherein the diverter-tongue element can be pushed forwards into the first switching position starting from the upstream guide-rail section of the two guide-rail sections relative to the conveying direction.

4. Suspension-type conveying arrangement according to claim 1, wherein the diverter-tongue element can be moved forwards telescopically into the first switching position, starting from the one guide-rail section, without interrupting the first conveying path between the diverter-tongue element and this guide-rail section.

5. Suspension-type conveying arrangement according to claim 1, wherein when the diverter-tongue element is transferred into the first switching position, an interspace is produced between the diverter-tongue element and the one guide-rail section, and wherein at least one guide-rail bridge element for bridging the interspace either is arranged on the diverter-tongue element, to be precise such that it can overlap laterally with the one guide-rail section when the diverter-tongue element is transferred into the second switching position, or is arranged on the one guide-rail section, to be precise such that it can overlap laterally with the diverter-tongue element when the diverter-tongue element is transferred into the second switching position.

6. Suspension-type conveying arrangement according to claim 5, wherein the guide-rail bridge element is a plate part which is fastened laterally on the diverter-tongue element on the guide-rail section and of which the top periphery is located at least more or less in a common plane with the top periphery of the diverter-tongue element and the top periphery of the one guide-rail section.

7. Suspension-type conveying arrangement according to claim 6, wherein the plate part is provided on both sides of the diverter-tongue element or of the guide-rail section.

8. Suspension-type conveying arrangement according to claim 1, wherein a switching-drive device which is intended for the diverter-tongue element and can be controlled by means of a diverter-control arrangement.

9. Suspension-type conveying arrangement according to claim 8, wherein the switching-drive device has a pneumatic or a hydraulic cylinder as switching-drive element.

10. Suspension-type conveying arrangement according to claim 8, wherein the switching-drive device has an electric motor or an electromagnet as switching-drive element.

11. Suspension-type conveying arrangement according to claim 9, wherein the switching-drive element is arranged on the one guide-rail section, in particular is integrated therein, and in that the diverter-tongue element is fastened on a diverter-tongue carrier of the switching-drive element, it being possible for this diverter-tongue carrier to be moved forwards and back along the guide-rail section.

12. Suspension-type conveying arrangement according to claim 1 wherein the diverter-tongue element, at its front end, has a sloping flank which, in the second switching position, forms a ramp for guiding conveyable-article-carrier hooks away downwards to the second conveying path.

13. Suspension-type conveying arrangement according to claim 1, wherein a traction arrangement is provided at least in association with the first conveying path, this traction arrangement having carry-along elements by means of which conveyable-article carriers which engage over the guide rail by way of their hooks are carried along the first conveying path.

14. Suspension-type conveying arrangement according to claim 13, wherein the carry-along elements are catches, pins or brush elements arranged on a traction belt or a traction chain.

15. Suspension-type conveying arrangement according to claim 1, comprising a sorting-conveyor region which contains the diverter.

16. Suspension-type conveying arrangement according to claim 15, wherein the sorting-conveyor region comprises a plurality of diverters.

17. Suspension-type conveying arrangement according to claim 8, wherein the diverter-control arrangement comprises a data-acquisition unite, in particular optical reading unit or transponder unit, for detecting relevant markings on the conveyable-article carriers fed to the diverter in each case or on conveyable articles located on the conveyable-article carriers.

18. Suspension-type conveying arrangement according to claim 1, wherein the diverter-tongue element can be moved back and forth between its switching positions in a state in which it rests on a supporting surface formed, in particular, on a guide rail of the second conveying path.
